(19) United States
(12) Patent Application Publication
(10) Pub. No.: US 2014/0122135 A1
(43) Pub. Date: May 1, 2014

(54) SYSTEMS AND METHODS FOR RANKING AND SELECTING ELIGIBILITY VENDORS

(71) Applicant: SALUCRO HEALTHCARE SOLUTIONS, LLC, Phoenix, AZ (US)

(72) Inventor: S. Clayton Bain, Phoenix, AZ (US)

(21) Appl. No.: 14/067,667

(22) Filed: Oct. 30, 2013

Related U.S. Application Data
(60) Provisional application No. 61/720,625, filed on Oct. 31, 2012.

(51) Int. Cl. G06Q 40/08

(52) U.S. Cl. CPC G06Q 40/08
USPC 705/4

(57) ABSTRACT

In various embodiments, a computer-based method may comprise: compiling, by a vendor ranking computer, eligibility rules and vendor statistics regarding vendor eligibility performance; receiving, by the computer, an eligibility request comprising eligibility parameters; querying, by the computer and based upon the eligibility parameters, a vendor database to determine a subset of eligibility vendors; analyzing, by the computer and based upon at least one of the eligibility rules and the vendor statistics, the subset of eligibility vendors; ranking, by the computer and based upon the analyzing, each vendor in the subset of vendors to produce a ranked vendor list; and providing, by the computer, the ranked vendor list to an eligibility system.

### CROSS-REFERENCE TO RELATED APPLICATIONS

This application claims priority to and the benefit of U.S. Provisional Application No. 61/720,625, filed on Oct. 31, 2012, which is hereby incorporated by reference.

### FIELD

The present disclosure generally relates to enabling determination of insurance verification and eligibility.

### BACKGROUND

Verifying insurance coverage and determining eligibility and/or coverage for certain services are important processes for businesses that depend upon insurance payments to at least partially cover the costs of services provided to customers. For instance, in the healthcare field, providers (e.g., doctors, hospitals, clinics, etc.) attempt to mitigate accounts receivable risk by determining whether a patient has insurance, and if so, what the insurance covers. Software vendors provide specialized software to address this need to query the payors (e.g., insurance providers), for coverage information. Such vendors may be referred to as “eligibility vendors.” However, typically no single eligibility vendor provides access to all payors and eligibility vendors vary with respect to the timeliness, completeness, accuracy and cost of the data that they provide. Thus, providers typically cannot rely on any single eligibility vendor.

As such, a long felt need exists for an integrated, end-to-end, automated system that ranks, based upon a query request from a provider, eligibility vendors based upon a multitude of factors including cost, accuracy, timeliness and historical performance.

### SUMMARY

In various embodiments, a computer-based method may comprise: compiling, by a vendor ranking computer, eligibility rules and vendor statistics regarding vendor eligibility performance; receiving, by the computer, an eligibility request comprising eligibility parameters; querying, by the computer and based upon the eligibility parameters, a vendor database to determine a subset of eligibility vendors; analyzing, by the computer and based upon at least one of the eligibility rules and the vendor statistics, the subset of eligibility vendors; ranking, by the computer and based upon the analyzing, each vendor in the subset of vendors to produce a ranked vendor list; and providing, by the computer, the ranked vendor list to an eligibility system.

In various embodiments, a system may comprise an eligibility processor; a tangible memory configured to communicate with the processor, the memory having instructions stored thereon that, in response to execution by the processor, may cause the processor to be capable of performing operations comprising: compiling, by the processor, eligibility rules and vendor statistics regarding vendor eligibility performance; receiving, by the processor, an eligibility request comprising eligibility parameters; querying, by the processor and based upon the eligibility parameters, a vendor database to determine a subset of eligibility vendors; analyzing, by the processor and based upon at least one of the eligibility rules and the vendor statistics, the subset of eligibility vendors; ranking, by the processor and based upon the analyzing, each vendor in the subset of vendors to produce a ranked vendor list; and providing, by the processor, the ranked vendor list to an eligibility system.

In various embodiments, an article of manufacture may include a non-transitory, tangible computer readable storage medium having instructions stored thereon that, in response to execution by an eligibility computer, may cause the value transfer computer to be capable of performing operations comprising: compiling, by the computer, eligibility rules and vendor statistics regarding vendor eligibility performance; receiving, by the computer, an eligibility request comprising eligibility parameters; querying, by the computer and based upon the eligibility parameters, a vendor database to determine a subset of eligibility vendors; analyzing, by the computer and based upon at least one of the eligibility rules and the vendor statistics, the subset of eligibility vendors; ranking, by the computer and based upon the analyzing, each vendor in the subset of vendors to produce a ranked vendor list; and providing, by the computer, the ranked vendor list to an eligibility system.

### BRIEF DESCRIPTION OF THE DRAWINGS

A more complete understanding of the present disclosure may be derived by referring to the detailed description and claims when considered in connection with the Figures, wherein like reference numbers refer to similar elements throughout the Figures, and:

FIG. 1 is a block diagram illustrating major system components of a vendor eligibility system, in accordance with various embodiments;

FIG. 2 is a flow chart illustrating an exemplary process for ranking eligibility vendors, in accordance with various embodiments; and

FIG. 3 is a depiction illustrating the inputs of a vendor ranking engine, in accordance with various embodiments.

### DETAILED DESCRIPTION

The systems and methods provide an improved, automated and intelligent eligibility system (“IES”) for determining and ranking of eligibility vendors while optimizing cost, speed, accuracy, completeness and consistency. “Entity” may include any software, hardware, system, individual, provider, payer, consumer, customer, group, business, organization, government entity, and/or any other entity. An “eligibility vendor” may include any entity that facilitates the determination of eligibility and/or coverage based upon an eligibility request.

Various embodiments of IES may be implemented by a system, computer readable medium, internet based system, a method or any combination thereof The systems and methods include a unique combination of one or more features associated with healthcare systems, eligibility software, eligibility systems, insurance systems, billing systems, and/or accounting systems.

An “account” or “account identifier” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to identify or associate an entity within a system (e.g., IES).

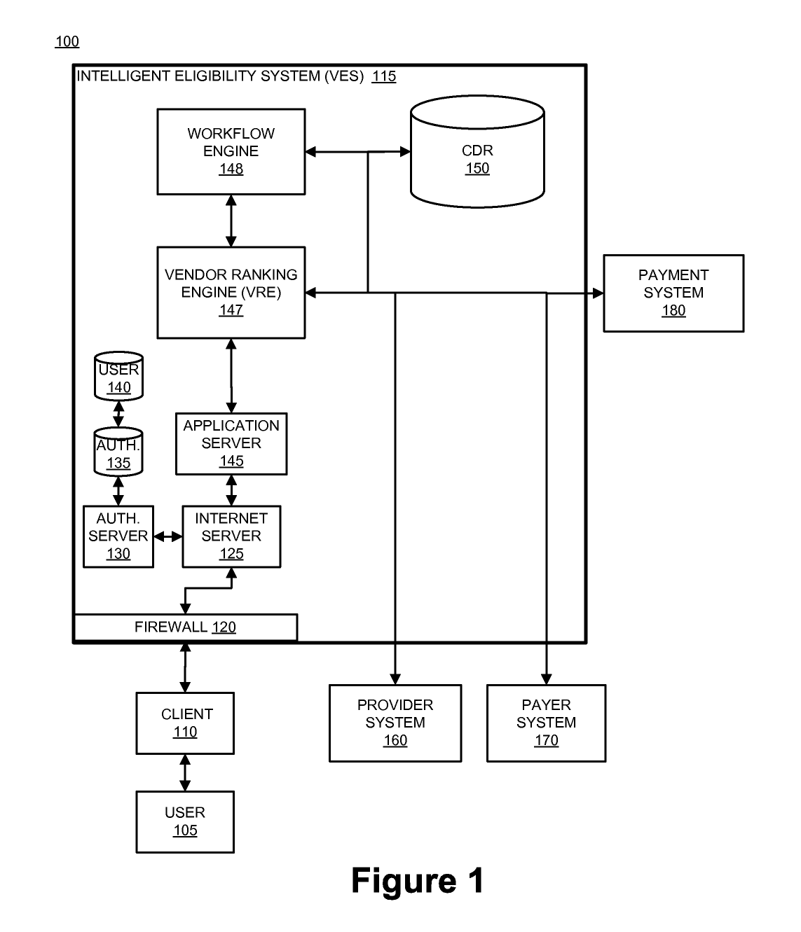

FIG. 1 shows an exemplary block diagram illustrating major system components for enabling IES 115. System 100 facilitates interaction between a user 105 and IES 115 through, in various embodiments, client 110 with a network connection to an Internet server 125 by way of the Internet. In various embodiments, Internet server 125 employs authentication server 130 to validate credentials, assign proper permissions, and retrieve preferences information for authorized user's 105 of IES 115.

In various embodiments, IES 115 interfaces and/or interacts with various interfacing systems such as, for example, provider system 160, payer system 170 and payment system 180. Such interfaces may be enabled via an application programming interface (“API”, not show in FIG. 1) or via custom integration, point-to-point interfaces, via a bus, a network or another system.

In various embodiments, Internet server 125 employs application server 145 to manage various applications and utilities that are utilized by system 100. In various embodiments, application server utilizes APL+Win, JBOSS utilizing SEAM, Richfaces JBPM, and/or other Java libraries (jQuery and Javascript), JAX-WS, Apache POI, and/or Quartz. In various embodiments, Internet server 125 interacts directly with the various systems and components disclosed herein.

IES 115 may include any number of computing platforms and databases such as, for example, vendor ranking engine (“VTE”) 147, workflow engine 148 and central data repository (“CDR”) 150. Other systems may include, for example, insurance systems, eligibility software and systems, payment systems, accounting systems, financial transaction systems, reporting systems, new accounts systems, management information systems, business information systems, external data sources, proprietary systems and the like. Each of the systems may be interconnected within by a network in via any method and/or device described herein. A middleware server and/or application server 145 may serve as an intermediary between the various systems to ensure appropriate communications between disparate platforms. A report engine retrieves and/or is provided with data from certain of the various systems in order to generate notices, offers, bills, messages, audit reports, and the like.

System 100, IES 115 and/or any other components discussed herein may further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases.

As will be appreciated by one of ordinary skill in the art, one or more of the components of system 100 may be embodied as a customization of an existing system, an add-on product, a processing apparatus executing upgraded software, a stand-alone system, a distributed system, a method executed by a computer, a data processing system, a device for data processing, and/or a computer program product. Accordingly, any portion of the system or a module may take the form of a processing apparatus executing code, an internet based embodiment, an entirely hardware embodiment, or an embodiment combining aspects of a network (e.g., the internet), software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system contemplates uses in association with cloud computing, web services, transaction processing, utility computing, pervasive and individualized computing, security and identity solutions, autonomic computing, commodity computing, mobility and wireless solutions, open source, biometrics, grid computing and/or mesh computing.

User 105 may include any entity that utilizes system 100 or IES 115 functionality. User 105 may include, for example, a user. In various embodiments, user 105 may interface with IES 115, CDR 150 or payment system 150 via any communication protocol, device or method discussed herein or known in the art. For example, user 105 may interact with IES 115 by way of a web interface (e.g. a “browser application”), an app or a custom application.

Client 110 comprises any hardware and/or software suitably configured to facilitate requesting, retrieving, updating, analyzing, entering and/or modifying data. For example, in various embodiments, client 110 is configured to facilitate input, receipt, presentations, analysis and/or review of information relating to social networking services, value transfer services, etc. Client 110 includes any device (e.g., personal computer) which communicates (in any manner discussed herein) with system 100 or IES 115 via any network discussed herein. Such browser applications comprise Internet browsing software and/or apps installed within a computing unit or system to conduct online transactions and/or communications. These computing units or systems may take the form of a computer or set of computers, although other types of computing units or systems may be used, including laptops, notebooks, hand held computers, set-top boxes, workstations, computer-servers, main frame computers, mini-computers, PC servers, pervasive computers, network sets of computers, and/or the like. Practitioners will appreciate that client 110 may or may not be in direct contact with IES 115. For example, client 110 may access the services of IES 115 via provider system 160, payer system 170, and/or through another server, which may have a direct or indirect connection to Internet server 125. Client 110 may be mobile or may be located in a home or business environment with access to a network. In an embodiment, access is through a network or the Internet through a commercially-available web-browser software package.

As those skilled in the art will appreciate, client 110 includes an operating system (e.g., Windows NT, 95/98/2000, OS2, UNIX, Linux, Solaris, MacOS, Android, iPhone OS etc.) as well as various conventional support software and drivers typically associated with computers, or computing devices. Client 110 may include any suitable personal computer, mobile device, phone, smart phone, network computer, workstation, minicomputer, mainframe or the like. Client 110 can be in a home or business environment with access to a network.

In various embodiments, various components, modules, and/or engines of system 100 may be implemented as micro-applications or “apps.” Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

Client 110 may be independently, separately or collectively suitably coupled to the network via data links which includes, for example, a connection to a wireless service provider or an Internet Service Provider (ISP). ISP connections over the local loop is typically used in connection with standard modem communication, cable modem, Dish networks, ISDN, Digital Subscriber Line (DSL), or various wireless communication methods, see, e.g., Gilbert Held, Understanding Data Communications (1996), which is hereby incorporated by reference. It is noted that the network may be implemented as other types of networks, such as an interactive television (ITV) network.

Client 110 may include any number of applications, code modules, cookies, and the like to facilitate interaction with the various components of system 100 as shown, for example in FIG. 1. Such interaction may include for example, input data, complete templates/forms, view reports, validate data, approve data, and the like. In various embodiments, client 110 may store user 105 preferences and/or any other information disclosed herein on a hard drive or any other local memory device. Accordingly, client 110 may retrieve and store consumer information within a memory structure of client 110 in the form of a browser cookie, for example. In various embodiments, client 110 retrieves information relating to user 105 from IES 115 on establishing a session with Internet server 125.

Firewall 120, as used herein, may comprise any hardware and/or software suitably configured to protect IES 115 components from users, other networks and systems. Firewall 120 may reside in varying configurations including stateful inspection, proxy based and packet filtering among others. Firewall 120 may be integrated as software within Internet server 125, any other IES 115 components or may reside within another computing device or may take the form of a standalone hardware component. Although depicted as a single firewall in FIG. 1, one skilled in the art will recognize that a firewall or multiple firewalls may be implemented throughout system 100 and/or IES 115 to enable system and data security.

Internet server 125 may include any hardware and/or software suitably configured to facilitate communications between client 110 and one or more IES 115 components. Further, Internet server 125 may be configured to transmit data to client 110 within markup language documents (e.g., XML, HTML, etc.). As used herein, “data” may include encompassing information such as commands, queries, files, data for storage, and/or the like in digital or any other form. Internet server 125 may operate as a single entity in a single physical location or as separate computing components located together or in separate physical locations.

Internet server 125 may provide a suitable web site or other Internet-based graphical user interface which is accessible by consumers. In various embodiments, Internet server 125 employs RedHat Linux Enterprise 5.x Server and Apache Http server. In various embodiments, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, InterBase, etc., may be used to provide an Active Data Object (ADO) compliant database management system.

Any of the communications, inputs, storage, databases or displays discussed herein may be facilitated through a web site having web pages. The term “web page” as it is used herein is not meant to limit the type of documents and applications that might be used to interact with the user. For example, a typical web site might include, in addition to markup language based documents (e.g., HTML), various forms, Java applets, JavaScript, active server pages (ASP), common gateway interface scripts (CGI), extensible markup language (XML), dynamic HTML, cascading style sheets (CSS), helper applications, plug-ins, and/or the like. A server may include a web service that receives a request from a web server, the request including a URL (e.g. http://yahoo.com/stockquotes/ge) and an IP address (e.g. 123.4.56.789). The web server retrieves the appropriate web pages and sends the data or applications for the web pages to the IP address. Web services are applications that are capable of interacting with other applications over a communications means, such as the Internet. Web services are typically based on standards or protocols such as XML, SOAP, WSDL and UDDI. Web services methods are well known in the art, and are covered in many standard texts. See, e.g., Alex Nghiem, IT Web Services: A Roadmap for the Enterprise (2003), hereby incorporated by reference.

In order to control access to components of IES 115, Internet server 125 may invoke authentication server 130 in response to user 105 submissions of authentication credentials received at Internet server 125 from client 110. Authentication server 130 may include any hardware and/or software suitably configured to receive authentication credentials, encrypt and decrypt credentials, authenticate credentials, and grant access rights according to privileges (e.g., pre-defined privileges) attached to the credentials. Authentication server 130 may grant varying degrees of application and data level access to users based on information stored within a database and/or any other known memory structure.

VRE 147 comprises hardware and/or software modules that execute processes, access data from CDR 150 and interact with workflow engine 148 to enable the functionality of IES 115. For example, VRE 147 may query CDR 150 to obtain a subset of vendors and associated vendor statistics and eligibility rules and use this information as input into a proprietary eligibility vendor ranking algorithm.

Workflow engine 148 comprises hardware and/or software modules that implement process definition, tracking and execution. Workflow engine 148 may comprise one or more software applications, modules or data objects. The software may be any executable code written in any software programming language, such as, for example Java®. For example, workflow engine 148 reads data from CDR 150 and instantiates a data object (e.g. a Java Bean®) to store the data for use by software modules or other objects.

CDR 150 may include any hardware and/or software suitably configured to facilitate storing data relating to, for example, eligibility rules, vendor statistics, historical data, cost data, contract data, vendor information, payer information, and the like.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In various embodiments, the system includes special purpose computers, user interfaces (UIs), software modules, logic and/or workflow engines, numerous databases and computer networks. While the system may contemplate upgrades or reconfigurations of existing processing systems, changes to existing databases and system tools are not necessarily required by the system and method.

While the description references specific technologies, hardware, equipment, system architectures and data management techniques, practitioners will appreciate that this description merely discusses various embodiments and that other devices and/or methods may be implemented without departing from the scope of the disclosure. Thus, the detailed description herein is presented for purposes of illustration only and not of limitation. Similarly, while the description may reference a user interfacing with the system via a personal computer user interface, practitioners will appreciate that other interfaces may include mobile devices, smart phones, tablet computing devices, kiosks and handheld devices such as personal digital assistants.

One skilled in the art will appreciate that system 100 may employ any number of databases in any number of configurations. Further, any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of system 100, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with system 100 by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

One skilled in the art will also appreciate that, for security reasons, any databases, systems, devices, servers or other components of system 100 may consist of any combination thereof at a single location or at multiple locations, wherein each database or system 100 includes any of various suitable security features, such as firewalls, access codes, encryption, decryption, compression, decompression, and/or the like.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot ®, Blackberry®), smart phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards and Protocols (1998); Java 2 Complete, various authors, (Sybex 1999); Deborah Ray and Eric Ray, Mastering HTML 4.0 (1997); and Loshin, TCP/IP Clearly Explained (1997) and David Gourley and Brian Totty, HTTP, The Definitive Guide (2002), the contents of which are hereby incorporated by reference.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/groups/SNS/cloud-computing/cloud-def-v15.doc (last visited Feb. 4, 2011), which is hereby incorporated by reference in its entirety.

The invention may be described herein in terms of functional block components, screen shots, optional selections and various processing steps. It should be appreciated that such functional blocks may be realized by any number of hardware and/or software components configured to perform the specified functions. For example, system 100 may employ various integrated circuit components, e.g., memory elements, processing elements, logic elements, look-up tables, and/or the like, which may carry out a variety of functions under the control of one or more microprocessors or other control devices.

Similarly, the software elements of system 100 may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Software elements (e.g., modules, engines, etc.) may be implemented as a web service. In various embodiments, web services are implemented using Webservice Interoperability Organization Basic Profile 1.1.

Further, it should be noted that system 100 may employ any number of conventional techniques for data transmission, signaling, data processing, network control, and/or the like. Still further, system 100 could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O′Reilly & Associates (1998); (3) “Cryptography & Network Security: Principles & Practice” by William Stallings, published by Prentice Hall; all of which are hereby incorporated by reference.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory (or “computer-readable medium”) that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts and/or the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Practitioners will appreciate that there are a number of methods for displaying data within a browser-based document. Data may be represented as standard text or within a fixed list, scrollable list, drop-down list, editable text field, fixed text field, pop-up window, and/or the like. Likewise, there are a number of methods available for modifying data in a web page such as, for example, free text entry using a keyboard, selection of menu items, check boxes, option boxes, and/or the like.

System 100 combines unique app, integration, data analysis and vendor ranking algorithms to enable eligibility vendor ranking and eligibility determination. While certain embodiments of the present invention are disclosed herein in terms of medical insurance eligibility, practitioners will appreciate that the teachings of the present invention may be equally applicable interchangeably between any type of insurance service or application.

Referring again to FIG. 1, in various embodiments, in response to user 105 accessing IES 115 (e.g., by logging onto an application or app), Internet server 125 may invoke an application server 145. Application server 145 invokes logic in VRE 147 by passing parameters relating to the user's 105 requests for data. IES 115 manages requests for data from VRE 147 and communicates with system 101 components. Transmissions between user 105 and Internet server 125 may pass through a firewall 120 to help ensure the integrity of IES 115 components. Practitioners will appreciate that the invention may incorporate any number of security schemes or none at all. In various embodiments, Internet server 125 receives requests from client 110 and interacts with various other system 100 components to perform tasks related to requests from client 110.

Internet server 125 may invoke an authentication server 130 to verify the identity of user 105 and assign roles, access rights and/or permissions to user 105. In order to control access to the application server 145 or any other component of IES 115, Internet server 125 may invoke an authentication server 130 in response to user 105 submissions of authentication credentials received at Internet server 125. In response to a request to access system 100 being received from Internet server 125, Internet server 125 determines if authentication is required and transmits a prompt to client 110. User 105 enters authentication data at client 110, which transmits the authentication data to Internet server 125. Internet server 125 passes the authentication data to authentication server which queries the user database 140 for corresponding credentials. When user 105 is authenticated, user 105 may access various applications and their corresponding data sources.

As discussed herein, responses provided by an eligibility vendor may vary on a payer by payer basis, vendor by vendor basis, and/or call (i.e. query) by call basis. Because of this, choosing any one particular eligibility vendor limits the probability of a successful or accurate eligibility request. IES 115 ranks multiple eligibility providers and enables the return of the most accurate information available.

In various embodiments, IES 115 enables an eligibility determination by ranking eligibility vendors and invoking (e.g. querying) a ranked eligibility vendor to determine insurance eligibility and/or estimated payment amounts. For example, a doctor's office (provider) may wish to determine whether a patient that is coming in for an appointment is currently covered by insurance (“status” or “insurance status”) and, if so, whether and in what amounts the insurance covers the services (“coverage”) that are anticipated to be performed by at the appointment. Determining such information is vital to a provider's financial management since many patients either do not have the ability or lack the will to pay significant out of pocket expenses.

The doctor's office wishes to query the patient's insurance company (i.e. the payor) to verify insurance status and coverage. However, as discussed herein, eligibility vendors do not provide access to all insurers. Thus, in various embodiments, the doctor's office accesses IES 115 (e.g., via an API) to perform the eligibility query. IES 115 is configured to optimize the search in order to minimize the cost and response time of the search and to maximize the quality of the search results.

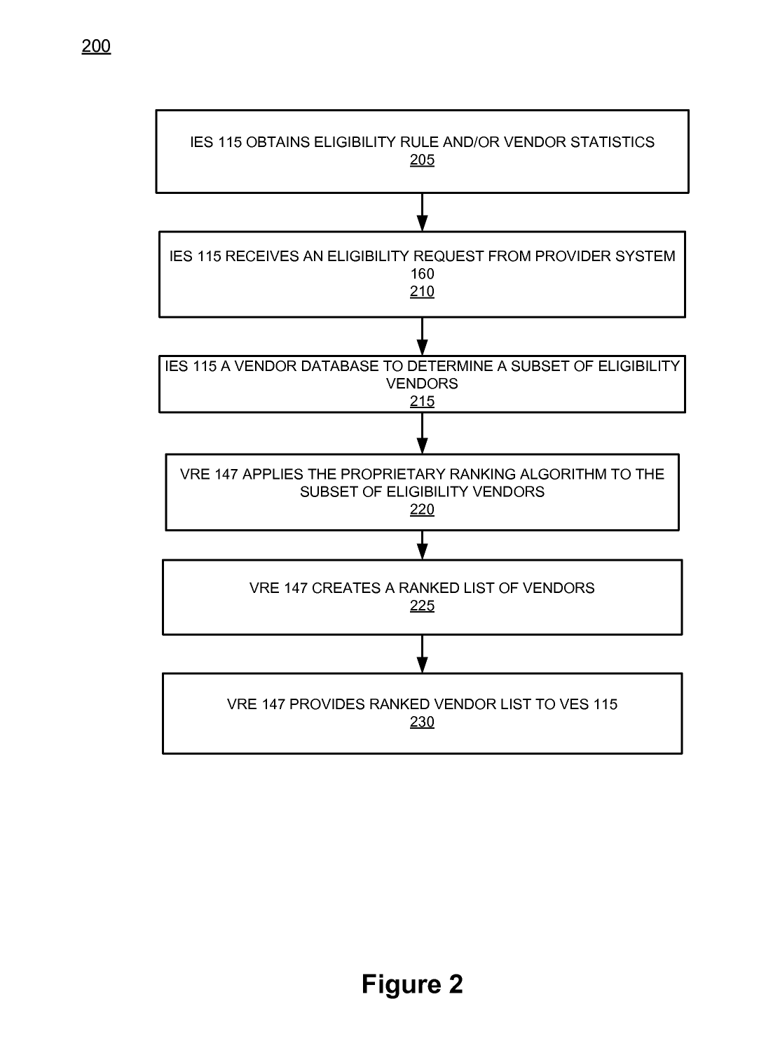

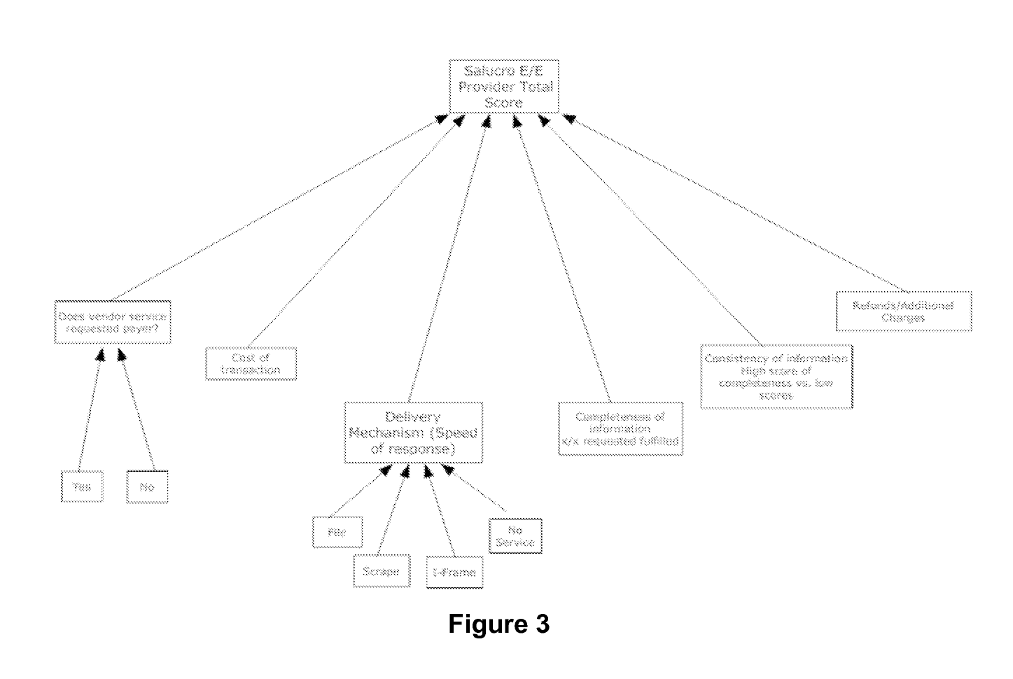

With reference now to FIG. 2, in various embodiments, IES 115 obtains eligibility rules and vendor statistics regarding vendor eligibility performance (Step 205). For example, IES 115 may compile vendor statistics based upon historical eligibility vendor queries and associated results. In various embodiments, with brief reference now to FIG. 3, such statistics may include, data completeness, data accuracy, data consistency, cost, response time, response delivery mechanism, and contract data. Data consistency may refer the consistency of results from a particular vendor given a set of input. For example, some vendors may provide inconsistent coverage results at different times of the day for the same query. In various embodiments, an eligibility vendor may charge different contract rates to conduct a query to the system based upon, for example, time of day or overall volume. For example, an eligibility vendor with a relatively high rate for a low volume of transactions may charge a much lower rate if the volume exceeds a threshold (e.g., such that a new contract rate is activated). Such tiered pricing contract data may be stored in CDR 150 and utilized by VRE 147 when ranking vendor costs; for example, it may be cheaper in the long run to use a high priced vendor if historical data shows that the query volume may reach a threshold for which much lower rates (and, thus, a lower average transaction cost) may be achieved.

In various embodiments, IES 115 may obtain eligibility rules and other parameters from CDR 150. For example, CDR 150 may be configured to store, and may be loaded with, a mapping of eligibility vendors and the providers that each supplies access to. As discussed previously, in the medical industry there may be hundreds of thousands of providers and no single eligibility vendor provides access to all providers. In various embodiments, IES 115 may access one or more external systems in order to determine which eligibility vendors provide access to which providers.

IES 115 receives an eligibility request from provider system 160 (Step 210). In various embodiments, the eligibility request may be received via an API, via a stand-alone client 110 not directly connected to provider system 160, and/or via a batch input file interface. The eligibility request includes eligibility parameters such as, for example, name of the insured, date of birth, employer information, date of employment, address information, sex, provider information, date of service, service code(s), payer (e.g. insurer) name, primary insurer, secondary insurer, etc.

IES 115 queries, based upon the eligibility parameters, a vendor database to determine a subset of eligibility vendors (Step 215). In various embodiments, IES 115 may not produce a subset vendor list and VRE 147 may apply the ranking algorithm to all of the eligibility vendors. In various embodiments, CDR 150 may include the vendor database. In various embodiments, querying the vendor database may include querying to determine which eligibility vendors provide eligibility access to the payor identified in the eligibility parameters.

VRE 147 applies the proprietary ranking algorithm to the subset of eligibility vendors (Step 220). In various embodiments, VRE 147 may access the eligibility rules and/or the vendor statistics in applying the ranking algorithm. For example, VRE 147 may access data regarding what result delivery mechanism is supported by the eligibility vendors. Such delivery mechanisms may include a file, screen scrape, web service, mail, I-frame, email, text message, etc. In various embodiments, the delivery mechanism supported by the eligibility vendor is a factor indicating the timeliness with which vendor eligibility requests may be provided. In various embodiments, VRE 147 accesses historical data completeness information that indicates the amount (e.g. number of data elements) received versus the amount requested from various eligibility vendors. In various embodiments, the algorithm may provide a single score for each eligibility vendor or may produce a score for each of several factors (e.g., cost, timeliness, accuracy).

VRE 147 creates a ranked list of eligibility vendors (Step 225) and provides the ranked vendor list to VES 115 (Step 230). In various embodiments, VES 115 system analyzes the ranked vendor list and queries one or more of the eligibility vendors to obtain eligibility results. The eligibility results may include, for example, insurance status, co-pay information, claim information (e.g. service codes), estimated payment information from payor, estimated out-of-pocket amount for insured, etc.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. The scope of the invention is accordingly to be limited by nothing other than the appended claims, in which reference to an element in the singular is not intended to mean “one and only one” unless explicitly so stated, but rather “one or more.” Moreover, where a phrase similar to ‘at least one of A, B, or C’ is used in the claims or specification, it is intended that the phrase be interpreted to mean that A alone may be present in various embodiments, B alone may be present in various embodiments, C alone may be present in various embodiments, or that any combination of the elements A, B and C may be present in a single embodiment; for example, A and B, A and C, B and C, or A and B and C. All structural, chemical, and functional equivalents to the elements of the above-described exemplary embodiments that are known to those of ordinary skill in the art are expressly incorporated herein by reference and are intended to be encompassed by the present claims. Further, a list of elements does not include only those elements but may include other elements not expressly listed or inherent to such process, method, article, or apparatus.

1. A computer-based method comprising:
compiling, by a vendor ranking computer, eligibility rules and vendor statistics regarding vendor eligibility performance;
receiving, by the computer, an eligibility request comprising eligibility parameters;
querying, by the computer and based upon the eligibility parameters, a vendor database to determine a subset of eligibility vendors;
analyzing, by the computer and based upon at least one of the eligibility rules and the vendor statistics, the subset of eligibility vendors;
ranking, by the computer and based upon the analyzing, each vendor in the subset of vendors to produce a ranked vendor list; and
providing, by the computer, the ranked vendor list to an eligibility system.

2. The method of claim 1, wherein the vendor statistics comprise at least one of data completeness, data accuracy, data consistency, cost, response time, response delivery mechanism, and contract data.

3. The method of claim 1, wherein the ranking is based upon a proprietary algorithm.

4. The method of claim 1, wherein the eligibility system queries, based upon the eligibility request, at least one vendor in the ranked vendor list in order to determine eligibility results.

5. The method of claim 1, wherein the eligibility system determines payment estimation based upon the eligibility results.

6. A system comprising:
an eligibility processor;
a tangible memory configured to communicate with the processor,
the memory having instructions stored thereon that, in response to execution by the processor, cause the processor to be capable of performing operations comprising:
compiling, by the processor, eligibility rules and vendor statistics regarding vendor eligibility performance;
receiving, by the processor, an eligibility request comprising eligibility parameters;
querying, by the processor and based upon the eligibility parameters, a vendor database to determine a subset of eligibility vendors;
analyzing, by the processor and based upon at least one of the eligibility rules and the vendor statistics, the subset of eligibility vendors;
ranking, by the processor and based upon the analyzing, each vendor in the subset of vendors to produce a ranked vendor list; and
providing, by the processor, the ranked vendor list to an eligibility system.

7. An article of manufacture including a non-transitory, tangible computer readable storage medium having instructions stored thereon that, in response to execution by an eligibility computer, cause the value transfer computer to be capable of performing operations comprising:
compiling, by the computer, eligibility rules and vendor statistics regarding vendor eligibility performance;
receiving, by the computer, an eligibility request comprising eligibility parameters;
querying, by the computer and based upon the eligibility parameters, a vendor database to determine a subset of eligibility vendors;
analyzing, by the computer and based upon at least one of the eligibility rules and the vendor statistics, the subset of eligibility vendors;
ranking, by the computer and based upon the analyzing, each vendor in the subset of vendors to produce a ranked vendor list; and
providing, by the computer, the ranked vendor list to an eligibility system.
